(19) United States
(12) Patent Application Publication
(10) Pub. No.: US 2023/0289746 A1
(43) Pub. Date: Sep. 14, 2023

(54) METHODS AND INTERNET OF THINGS SYSTEMS FOR CREATING SMART GAS CALL CENTER WORK ORDERS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Yong LI, Chengdu (CN); Xiaojun WEI, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/321,764

(22) Filed: May 22, 2023

(30) Foreign Application Priority Data
Mar. 3, 2023 (CN) 202310197535.1

(51) Int. Cl. G06Q 10/20; G06Q 50/06

(52) U.S. Cl. CPC G06Q 10/20; G06Q 50/06

(57) ABSTRACT

The embodiment of the present disclosure provides a method and Internet of things (IoT) system for creating a smart gas call center work order. The IoT system includes a smart gas user platform, a smart gas service platform, a smart gas safety management platform, a smart gas sensor network platform and a smart gas object platform. The method is executed by the smart gas safety management platform, including: obtaining maintenance work order information; determining, based on the maintenance work order information, a maintenance type and a maintenance difficulty level of at least one maintenance task; predicting, based on the maintenance type and the maintenance difficulty level, a man-hour requirement and a material requirement for the at least one maintenance task; and determining, based on the man-hour requirement and the material requirement, a work order allocation plan.

### CROSS-REFERENCE TO RELATED APPLICATION

This application claims priority of Chinese Patent Application No. 202310197535.1 filled on Mar. 3, 2023, the contents of each of which are entirely incorporated herein by reference.

### TECHNICAL FIELD

The present disclosure relates to the field of gas management system, and in particular, to a method and an Internet of things system for creating a smart gas call center work order.

### BACKGROUND

As a service manner using modern communication means and computer technology, a call center has become an important part of people's life. In a multi-departmental collaboration, a work order is an important basis for work collaboration. Usually, the call center creates a work order after receiving call information and waits for a maintenance person to accept the order or designate a maintenance person to process the work order, resulting in a redundant person and a waste of material, and causing a low work order processing efficiency and a poor user experience.

Aiming at the problem of how to improve the work order processing efficiency, CN102572134B proposes a method and a system for processing a work order. This application adopts an automatic information completion manner for an establishment process of a work order, so that the user does not need to carry out redundant work like an authentication or provide extra personal information when using the call services. However, as there is an obvious difference between user information in the work order and information on what actually needs to be repaired, it is still necessary to process the information of the maintenance task that actually needs to be repaired before the work order is allocated.

Therefore, a method and an Internet of Things system for creating a smart gas call center work order is provided. Through the maintenance work order information, the man-hour requirement and the material requirement for the maintenance task may be predicted, and the work order allocation plan may be intelligently determined to improve the work order processing efficiency and improve the user experience.

### SUMMARY

One or more embodiments of the present disclosure provide a method for creating a smart gas call center work order. The method is executed by a smart gas safety management platform of an Internet of things (IoT) system for creating a smart gas call center work order, and the method includes: obtaining maintenance work order information; determining, based on the maintenance work order information, a maintenance type and a maintenance difficulty level of at least one maintenance task; predicting, based on the maintenance type and the maintenance difficulty level, a man-hour requirement and a material requirement for the at least one maintenance task; and determining, based on the man-hour requirement and the material requirement, a work order allocation plan.

One or more embodiments of the present disclosure provide an IoT system for creating a smart gas call center work order, the smart gas safety management platform of the IoT system for creating a smart gas call center work order is configured to: obtain maintenance work order information; determine, based on the maintenance work order information, a maintenance type and a maintenance difficulty level of at least one maintenance task; predict based on the maintenance type and the maintenance difficulty level, a man-hour requirement and a material requirement of the at least one maintenance task; and determine, based on the man-hour requirement and the material requirement, a work order allocation plan.

One or more embodiments of the present disclosure provide a non-transitory computer readable storage medium, wherein the storage medium stores computer instructions, when the computer instructions are executed by a processor, the method for creating a smart gas call center work order.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which the same reference numbers represent the same structures, and wherein:

FIG. 1 is a schematic diagram illustrating an exemplary Internet of Things (IoT) system for creating a smart gas call center work order according to some embodiments of the present disclosure;

FIG. 2 is a flowchart illustrating an exemplary method for creating a smart gas call center work order according to some embodiments of the present disclosure;

FIG. 3 is a schematic diagram illustrating an exemplary maintenance prediction model according to some embodiments of the present disclosure;

FIG. 4 is a flowchart illustrating an exemplary process for determining a man-hour requirement according to some embodiments of the present disclosure;

FIG. 5 is a schematic diagram illustrating an exemplary process for determining a material requirement according to some embodiments of the present disclosure; and

FIG. 6 is a flowchart illustrating an exemplary process for determining a work order allocation plan according to some embodiments of the present disclosure.

### DETAILED DESCRIPTION

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts. The terminology used herein is for the purposes of describing particular examples and embodiments only and is not intended to be limiting. As used herein, the singular forms “a,” “an,” and “the” may be intended to include the plural forms as well, unless the context clearly indicates otherwise.

Creating a work order involves a complex content, and different processes for creating the work order use different methods, so the methods to improve a work order processing efficiency may further be different. In some embodiments of the present disclosure, a maintenance type, and a maintenance difficulty level of at least one maintenance task are determined according to maintenance work order information, and a man-hour requirement and a material requirement for the at least one maintenance task are predicted based on the maintenance type and the maintenance difficulty level. A maintenance person level may affect a length of a maintenance time of the maintenance person, and a consideration of the man-hour requirement is realized based on the maintenance person, the maintenance type, and the maintenance difficulty level. In addition, combined with the man-hour requirement and the material requirement for the maintenance task, the work order allocation plan may be intelligently and dynamically determined, thereby improving a work order processing efficiency and a user experience.

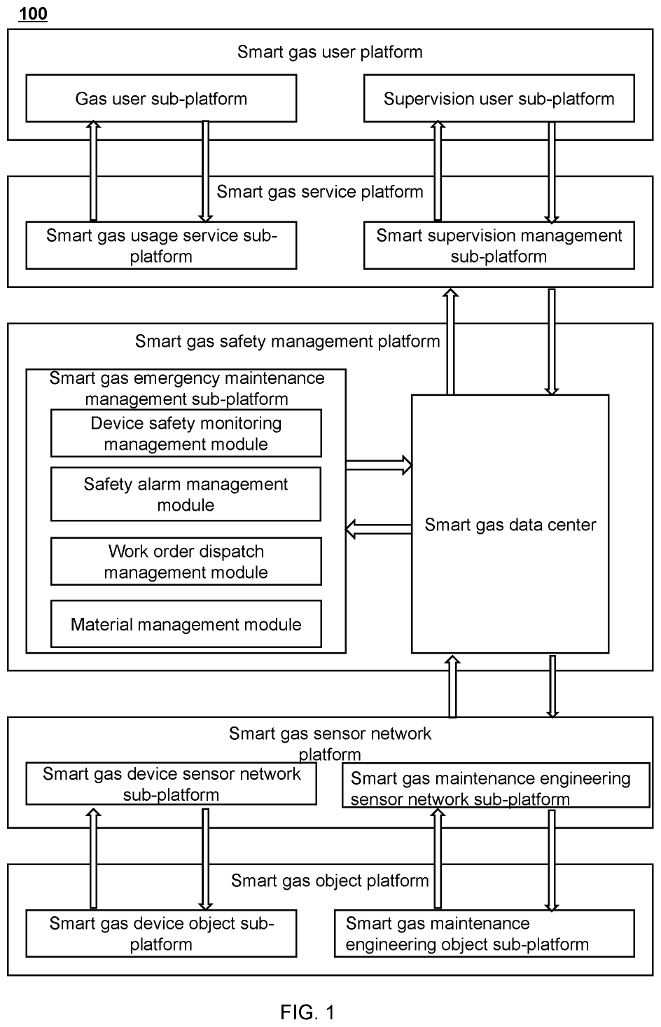

FIG. 1 is a schematic diagram illustrating an exemplary Internet of Things (IoT) system for creating a smart gas call center work order according to some embodiments of the present disclosure. As shown in FIG. 1, an IoT system 100 for creating a smart gas call center work order may include a smart gas user platform, a smart gas service platform, a smart gas safety management platform, a smart gas sensor network platform, and a smart gas object platform.

The smart gas user platform may be a user-oriented platform that obtains a requirement of a user and feeds back information to the user.

In some embodiments, the smart gas user platform may include a gas user sub-platform and a supervision user sub-platform. A gas user may be a user of the gas call center work order, and a supervision user may be a manager or a government person of the gas call center work order. The smart gas user platform may obtain a user input instruction through a terminal device and query information related to the gas call center work order.

The smart gas service platform may be a platform that provides information/data transmission and interaction.

In some embodiments, the smart gas service platform may be configured for information and/or data interaction between the smart gas safety management platform and the smart gas user platform. The smart gas service platform may be configured to send a work order allocation plan to the smart gas user platform.

In some embodiments, the smart gas service platform may include a smart gas usage service sub-platform and a smart supervision service sub-platform. The smart gas usage service sub-platform may be configured to receive reminder information sent by the smart gas safety management platform and send the reminder information to the gas user sub-platform. The smart supervision service sub-platform may be configured to receive emergency maintenance management information sent by the supervision user sub-platform, and send the emergency maintenance management information to the smart gas safety management platform.

The smart gas safety management platform may refer to an IoT platform for overall planning and coordinating connections and cooperation among various functional platforms and providing functions of perceptual management and control management.

In some embodiments, the smart gas safety management platform may be configured for information and/or data processing. The smart gas safety management platform may be configured for device safety monitoring management, safety alarm management, work order dispatch management, and material management.

In some embodiments, the smart gas safety management platform may be further configured for information and/or data interaction between the smart gas service platform and the smart gas sensor network platform. The smart gas safety management platform may receive the emergency maintenance management information sent by the smart gas service platform, store and process the emergency maintenance management information, and send it to the smart gas sensor network platform. The smart gas safety management platform may further obtain operation information from the smart gas sensor network platform, store and process the operation information, and send it to the smart gas service platform.

In some embodiments, the smart gas safety management platform may include a smart gas emergency maintenance management sub-platform and a smart gas data center. The smart gas emergency maintenance management sub-platform includes a device safety monitoring management module, a safety alarm management module, a work order dispatch management module, and a material management module.

The smart gas data center may be a data management sub-platform for storing, retrieving, and transferring data. The smart gas data center may be configured to send a material requirement for a maintenance task to the smart gas service platform.

The smart gas sensor network platform may refer to a platform for unified management of sensor communications between the platforms in the IoT system 100 for creating the smart gas call center work order.

In some embodiments, the smart gas sensor network platform may include a smart gas device sensor network sub-platform and a smart gas maintenance engineering sensor network sub-platform.

In some embodiments, the smart gas device sensor network sub-platform may correspond to the smart gas device object sub-platform. The smart gas device sensor network sub-platform may receive data related to a gas device uploaded by the smart gas device object sub-platform.

In some embodiments, the smart gas maintenance engineering sensor network sub-platform may correspond to the smart gas maintenance engineering object sub-platform. The smart gas maintenance engineering sensor network sub-platform may receive data related to maintenance engineering uploaded by the smart gas maintenance engineering object sub-platform.

In some embodiments, the smart gas sensor network platform may interact with the smart gas object platform. The smart gas sensor network platform may receive the data related to the gas device and/or the data related to the maintenance engineering uploaded by the smart gas object platform. The smart gas sensor network platform may send an instruction for obtaining the data related to the gas device and/or the data related to the maintenance engineering to the smart gas object platform.

The smart gas object platform may be a functional platform for a generation of perception information and final execution of control information and may be configured as various gas devices and maintenance engineering. The smart gas object platform may include a smart gas device object sub-platform and a smart gas maintenance engineering object sub-platform.

In some embodiments, the smart gas object platform is configured to obtain an execution progress of the work order allocation plan. The smart gas object platform may further transfer the work order allocation plan to the smart gas safety management platform through the smart gas sensor network platform. The execution progress refers to a completion degree of the maintenance task in the work order allocation plan.

Through an IoT functional architecture with five platforms, a smart gas storage optimization is implemented, and a closed loop of the information process is completed, so that the IoT information processing may be smoother and more efficient.

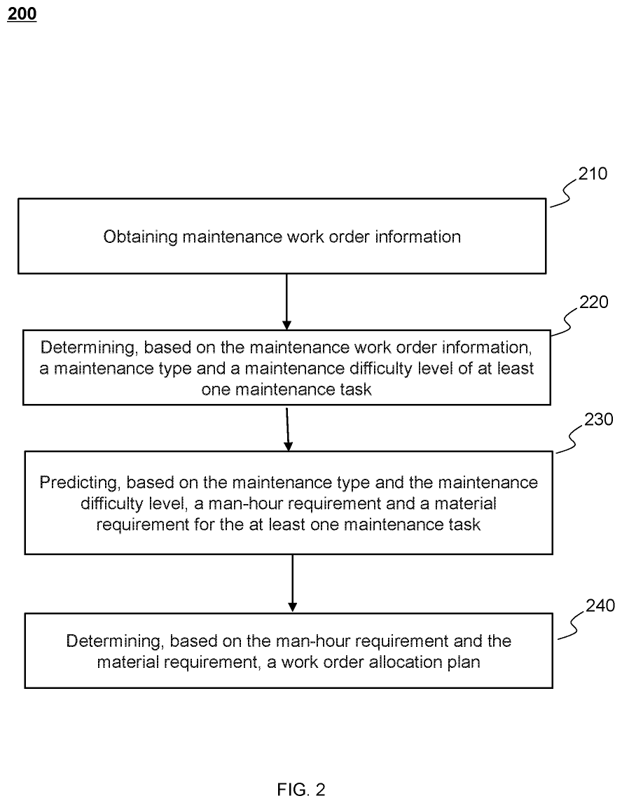

FIG. 2 is a flowchart illustrating an exemplary method for creating a smart gas call center work order according to some embodiments of the present disclosure. A process 200 may be executed by the smart gas safety management platform. As shown in FIG. 2, the process 200 includes the following operations.

In 210, obtaining maintenance work order information.

The maintenance work order is a work order indicating that a gas device has a problem and needs to be repaired. The maintenance work order information refers to relevant information that reflects the maintenance work order.

The maintenance work order information may include user information, a maintenance location, a maintenance device type, a current status of the maintenance device, image data and/or audio data uploaded by a user, etc. The current status of the maintenance device may be represented by current data of the maintenance device (such as data reflecting that a water heater is not heating, data reflecting that a gas stove cannot be ignited, etc.), and the image data and/or audio data uploaded by the user may be an abnormal image of the maintenance device (such as an image showing that a water heater light is off), an abnormal audio of the maintenance device making a harsh sound, etc.

In some embodiments, the maintenance work order information may further include maintenance device information. The maintenance device information may include device usage information, device maintenance information, current detection information of the device, etc. For example, the device usage information may be a service life of the device, a usage frequency of the device being used, etc., the device maintenance information may be a maintenance frequency of the device, etc., and the current detection information of the device may be a gas flow of the device, etc.

In some embodiments, the maintenance device information may be obtained based on the maintenance location, the maintenance device type, etc.

In some embodiments, the maintenance work order information may be obtained by a user calling. For example, when a user calls a call center, the call center may obtain maintenance work order information of the user. In some embodiments, the maintenance work order information may be obtained based on the smart gas user platform. For example, the maintenance work order information may be obtained through the gas user sub-platform in the smart gas user platform.

In some embodiments, the maintenance device information of the maintenance work order information may be obtained based on the smart gas object platform. For example, the maintenance device information may be obtained through the smart gas device object sub-platform or the smart gas maintenance engineering object sub-platform in the smart gas object platform.

In 220, determining, based on the maintenance work order information, a maintenance type and a maintenance difficulty level of at least one maintenance task.

The maintenance task refers to a work related to the maintenance of the gas device. Different maintenance tasks may correspond to different maintenance types and maintenance difficulty levels.

The maintenance type refers to a relevant classification for the maintenance of the gas device. For example, the maintenance type may be classified in terms of degrees as major maintenance, item maintenance, minor maintenance, etc. In some embodiments, a relationship between the maintenance work order information and the maintenance type may be preset, and the maintenance type of the at least one maintenance task may be obtained according to the preset relationship.

The maintenance difficulty level refers to a classification of a relevant difficulty in the maintenance of the gas device. For example, the maintenance difficulty level may be represented by numbers, such as 1-9, where 1 represents easy and 9 represents difficult. The maintenance work order information may be processed to obtain the maintenance difficulty level of the at least one maintenance task.

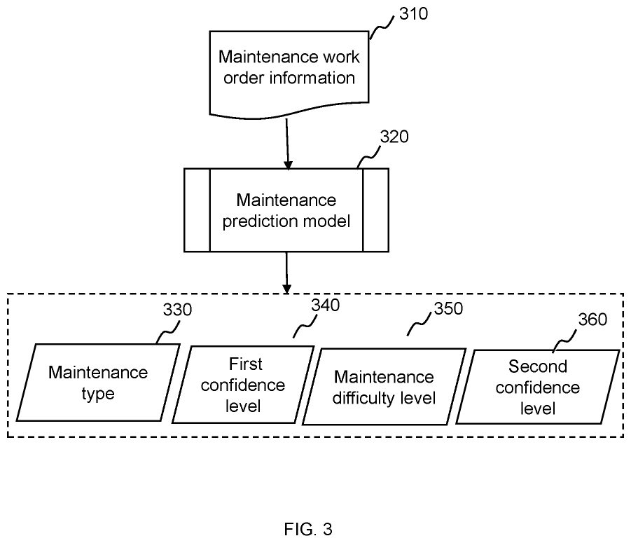

In some embodiments, the maintenance work order information may be processed based on a maintenance prediction model to determine the maintenance type and the maintenance difficulty level as well as their corresponding confidence levels. Please refer to FIG. 3 for details about the maintenance prediction model.

In 230, predicting, based on the maintenance type and the maintenance difficulty level, a man-hour requirement and a material requirement for the at least one maintenance task.

The man-hour requirement refers to a time required for maintaining the gas device. The man-hour requirement may include a maintenance time, a travel time, etc.

In some embodiments, the smart gas safety management platform may predict the man-hour requirement for the at least one maintenance task based on the maintenance type and the maintenance difficulty level. For example, when the maintenance type is the major maintenance and/or the maintenance difficulty level is high, the man-hour requirement for the maintenance task may be large. In some embodiments, the man-hour requirement for the at least one maintenance task may be predicted based on the maintenance work order information. For example, when the maintenance location is far away, the man-hour requirement for the maintenance task may be large.

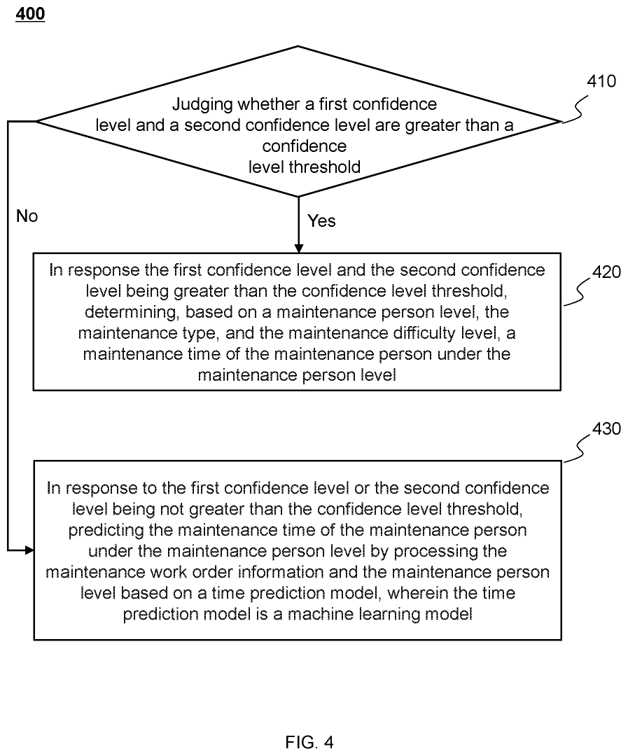

In some embodiments, the maintenance time in the man-hour requirement may be predicted based on a time prediction model. In response to that a first and/or second confidence level is not greater than a confidence level threshold, the maintenance work order information and a maintenance person level may be processed based on a time prediction model to predict the maintenance time of a maintenance person under the corresponding maintenance person level. See FIG. 4 for details about the above-mentioned related content.

In some embodiments, the maintenance time in the man-hour requirement may be related to the maintenance person level. It may be judged whether the first and second confidence levels are greater than the confidence level threshold; in response to that the first and second confidence levels are greater than the confidence level threshold, the maintenance time of the maintenance person under the corresponding maintenance person level may be determined based on the maintenance person level, the maintenance type, and the maintenance difficulty level. See FIG. 4 for details about the maintenance person level and predicting the maintenance time.

The material requirement refers to a maintenance material requirement for repairing the gas device. For example, the material requirement may be a filter screens, a pipe, a fan, etc., that needs to be replaced in the gas device, as well as an amount of the above materials.

In some embodiments, the material requirement for the at least one maintenance task may be determined in various ways. For example, a material requirement comparison table may be preset, and according to different material requirements corresponding to different maintenance tasks, the current material requirement corresponding to the current maintenance task may be determined by checking the table. The material requirement comparison table may include different maintenance tasks and their corresponding material requirements (including the materials required and usage volumes of different materials). The material requirement comparison table may be summarized and obtained based on a historical maintenance task and a corresponding historical material requirement. For example, through a corresponding relationship between the historical maintenance task and the historical material requirement, the current material requirement may be determined according to the current maintenance task and based on the material requirement comparison table.

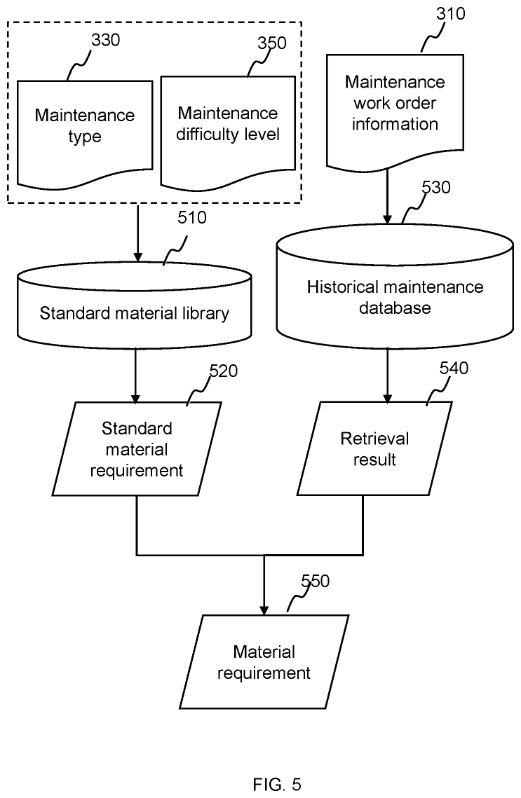

In some embodiments, a standard material requirement for the at least one maintenance task may be determined through a standard material library and based on the maintenance type and the maintenance difficulty level; a retrieval result may be determined based on the maintenance work order information through a historical maintenance database; and the material requirement for the at least one maintenance task may be determined based on the retrieval result and the standard material requirement. Please refer to FIG. 5 for details on determining the material requirement for the maintenance task.

In 240, determining, based on the man-hour requirement and the material requirement, a work order allocation plan.

The work order allocation plan refers to a relevant distribution plan for maintaining the gas device. The work order allocation plan may include at least one maintenance person for the maintenance task. In some embodiments, the maintenance person may be determined based on the man-hour requirement and the material requirement for the at least one maintenance task, and then the work order allocation plan may be determined based on the maintenance person. For example, when the man-hour requirement for the maintenance task is large, and the material requirement is a material with high cost, the maintenance person may be a senior maintenance person.

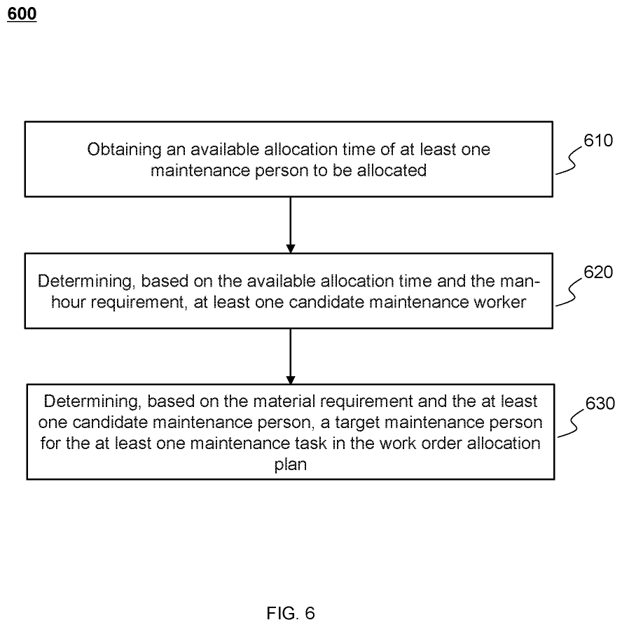

In some embodiments, an available allocation time of at least one maintenance person to be allocated may be obtained; at least one candidate maintenance person may be determined based on the available allocation time and the man-hour requirement; and a target maintenance person for the at least one maintenance task in the work order allocation plan may be determined based on the material requirement and the at least one candidate maintenance person. Please refer to FIG. 6 for details about determining the work order allocation plan.

Through the maintenance work order information, the maintenance type and the maintenance difficulty level of the maintenance task may be determined. Combined with the man-hour requirement and the material requirement for the maintenance task, the work order allocation plan can be determined intelligently and dynamically, which greatly improves the efficiency of work order processing and avoids an excessive idleness or busyness of the maintenance person, which improves the user experience.

FIG. 3 is a schematic diagram illustrating an exemplary maintenance prediction model according to some embodiments of the present disclosure.

In some embodiments, maintenance work order information 310 may be processed based on a maintenance prediction model 320 to determine a maintenance type 330, a first confidence level 340 of the maintenance type 330, a maintenance difficulty level 350, and a second confidence level 360 of the maintenance difficulty level 350. The maintenance prediction model 320 may be a machine learning model.

The first confidence level 340 refers to a credibility of the predicted maintenance type 330. The first confidence level 340 may be obtained by processing the maintenance work order information by the maintenance prediction model 320.

The second confidence level 360 refers to the credibility of the predicted maintenance difficulty level 350. The second confidence level 360 may be obtained by processing the maintenance work order information by the maintenance prediction model 320.

In some embodiments, weights of material usage data and a standard material requirement may be determined based on the first and second confidence levels. Please refer to FIG. 5 for descriptions of the weights of the material usage data and the standard material requirement.

The maintenance prediction model 320 may be a deep neural network (DNN) model, a convolutional neural network (CNN) model, etc., or any combination thereof.

In some embodiments, as shown in FIG. 3, an input of the maintenance prediction model 320 may include the maintenance work order information 310. An output of the maintenance prediction model 320 may include the maintenance type 330 corresponding to the maintenance work order, the first confidence level 340 of the maintenance type 330, the maintenance difficulty level 350, and the second confidence level 360 of the maintenance difficulty level 350. Please refer to FIG. 2 for descriptions of the maintenance type and the maintenance difficulty level.

In some embodiments, the maintenance prediction model 320 may be obtained by training a plurality of labeled first training samples. The plurality of labeled first training samples may be input into an initial maintenance prediction model, a loss function may be constructed through the labels and results of the initial maintenance prediction model, and parameters of the initial maintenance prediction model may be iteratively updated based on the loss function. When the loss function of the initial maintenance prediction model satisfies a preset condition, the model training is completed, and a trained maintenance prediction model may be obtained. The preset condition may be that the loss function converges, the count of iterations reaches a threshold, etc.

In some embodiments, the first training sample may include sample maintenance work order information. The label may be an actual maintenance type corresponding to the sample maintenance work order information, the first confidence level of the actual maintenance type, the actual maintenance difficulty level, and the second confidence level of the actual maintenance difficulty level. The first training sample may include a positive sample and a negative sample. The label corresponding to the positive sample is the actual maintenance type corresponding to the sample maintenance work order information, a first confidence level of the actual maintenance type being 1, the actual maintenance difficulty level, and a second confidence level of the actual maintenance difficulty level being 1. The label corresponding to the negative sample is the maintenance type corresponding to the sample maintenance work order information (if it is not the actual maintenance type corresponding to the sample maintenance work order information, it is a wrong maintenance type), a first confidence level of the maintenance type being 0, the maintenance difficulty level (if it is not the actual maintenance difficulty level corresponding to the sample maintenance work order information, it is a wrong maintenance difficulty level), and a second confidence level of the maintenance difficulty level being 0.

In some embodiments, the first training sample may be obtained through a big data analysis, and the label may be obtained through a manual labeling. Historical practice data of the actual maintenance type and maintenance difficulty level of the maintenance work order information may be obtained in a form of practice. For example, the positive sample may be comprehensively rated based on a historical maintenance time and a level of a historical maintenance person, and a label of the maintenance difficulty level may be automatically generated based on the rating. The negative sample may be adjusted according to a preset adjustment range on the basis of the above positive sample.

The maintenance prediction model 320 determines the maintenance type 330, the first confidence level 340 of the maintenance type 330, the maintenance difficulty level 350, and the second confidence level 360 of the maintenance difficulty level 350 based on the maintenance work order information 310. In this way, the man-hour requirement and material requirement for the maintenance task can be accurately predicted, and the maintenance person and the materials can be more precisely allocated.

In some embodiments, the input of the maintenance prediction model 320 may further include an audio data feature and/or an image data feature. The audio data feature is obtained through an audio feature extraction layer of an audio recognition model. The image data feature is obtained through an image feature extraction layer of an image recognition model. The audio recognition model includes the audio feature extraction layer and an audio anomaly recognition layer. The image recognition model includes the image feature extraction layer and an image anomaly recognition layer. The audio anomaly recognition layer is configured to determine whether the audio data is abnormal based on the audio data feature. The image anomaly recognition layer is configured to determine whether the image data is abnormal based on the image data feature. The image recognition model and the audio recognition model may be machine learning models.

The audio data feature refers to data information reflecting a certain feature of an audio signal. The audio data feature may be obtained through the audio feature extraction layer of the audio recognition model.

In some embodiments, the audio recognition model may be configured to extract the audio data feature to determine whether the audio data is abnormal. The audio recognition model may be a deep neural network model, a convolutional neural network model, or the like, or any combination thereof.

An input of the audio feature extraction layer may include the audio data. The audio data may be uploaded and obtained by the user. An output of the audio feature extraction layer may include the audio data feature.

An input of the audio anomaly recognition layer may include the audio data feature. An output of the audio anomaly recognition layer may include whether the audio data is abnormal.

In some embodiments, the audio feature extraction layer and the audio anomaly recognition layer may be jointly trained.

In some embodiments, a second training sample of the joint training may include sample audio data, and the label is whether the sample audio data is abnormal. The sample audio data may be input to the audio feature extraction layer to obtain the audio data feature output by the audio feature extraction layer; the audio data feature may be input to the audio anomaly recognition layer as sample training data to obtain whether the audio data output by the audio anomaly recognition layer is abnormal. A loss function may be constructed based on whether the sample audio data is abnormal and whether the audio data output by the audio anomaly recognition layer is abnormal, and the parameters of the audio feature extraction layer and the audio anomaly recognition layer may be updated synchronously. Through the parameter updating, a trained audio feature extraction layer and audio anomaly recognition layer may be obtained. In some embodiments, the second training sample may be obtained through the big data analysis, and the label may be obtained through the manual labeling.

The image data feature refers to data information reflecting a certain feature of the image data. The image data feature may be obtained through the image feature extraction layer of the image recognition model.

In some embodiments, the image recognition model may be used to extract an image data feature to determine whether the image data is abnormal. The image recognition model may be a deep neural network model, a convolutional neural network model, or the like, or any combination thereof.

An input of the image feature extraction layer may include the image data. The image data may be uploaded and obtained by users. An output of the image feature extraction layer may include the image data feature.

An input of the image anomaly recognition layer may include the image data feature. An output of the image anomaly recognition layer may include whether the image data is abnormal.

In some embodiments, the image feature extraction layer and the image anomaly recognition layer may be jointly trained.

In some embodiments, a third training sample of the joint training includes sample image data, and the label is whether the sample image data is abnormal. The process of the joint training of the image feature extraction layer and the image anomaly recognition layer is similar to the process of the joint training of the audio feature extraction layer and the audio anomaly recognition layer, please refer to the relevant description above.

By training the audio recognition model and the image recognition model using training samples with sufficient training data, a more accurate audio feature extraction layer and image feature extraction layer can be obtained, and then more accurate audio data feature and image data feature can be obtained. Incorporating the above features into the input of the maintenance prediction model 320 helps to more accurately determine the maintenance type 330 and the maintenance difficulty level 350 of the maintenance task.

The input of the maintenance prediction model 320 may further include the audio data feature and/or the image data feature, and the first training sample may further include a sample audio data feature and/or a sample image data feature.

FIG. 4 is a flowchart illustrating an exemplary process for determining a man-hour requirement according to some embodiments of the present disclosure. A process 400 may be performed by the smart gas safety management platform. As shown in FIG. 4, the process 400 includes the following operations.

In some embodiments, the man-hour requirement may include a maintenance time. The maintenance time refers to the time required for a maintenance person with a preset maintenance level to perform a maintenance work.

In 410, judging whether a first confidence level and a second confidence level are greater than a confidence level threshold. Please refer to FIG. 3 for details about the first and second confidence levels.

The confidence level threshold may be a preset minimum value of the confidence level of the maintenance type and the maintenance difficulty level. In some embodiments, thresholds corresponding to the first and second confidence levels may be the same or different. Correspondingly, the confidence level threshold may be one value or two values, and the specific value may be set according to an actual requirement.

When both the first and second confidence levels are greater than the corresponding confidence level threshold(s), operation 420 may be performed, otherwise, operation 430 may be performed.

In 420, in response to the first confidence level and the second confidence level being greater than the confidence level threshold, determining, based on a maintenance person level, the maintenance type, and the maintenance difficulty level, the maintenance time of the maintenance person under the maintenance person level. Please refer to FIG. 2 for details on the maintenance type and the maintenance difficulty level.

The maintenance person refers to a person who uses the maintenance material to perform the maintenance work. The maintenance person level refers to a maintenance technical level of the maintenance person. The maintenance person level may include a common level, an intermediate level, a senior level, etc. The maintenance person and the maintenance person level may be obtained by inputting into the IoT system in advance.

The maintenance time may be determined in variety of ways. In some embodiments, tables related to different maintenance frequency corresponding to different maintenance types, different maintenance person levels, and different maintenance difficulty levels may be pre-recorded and saved. After obtaining the maintenance type and the maintenance difficulty level, the maintenance time may be determined by checking the tables according to the maintenance person level.

In some embodiments, the process 400 may further include operation 430, in response to the first confidence level and/or the second confidence level being not greater than the confidence level threshold, predicting the maintenance time of the maintenance person under the maintenance person level by processing the maintenance work order information and the maintenance person level based on a time prediction model. The time prediction model is a machine learning model.

In some embodiments, the time prediction model may be configured to predict the maintenance time of the maintenance person under the corresponding maintenance person level. The prediction model may be a deep neural network model, a convolutional neural network model, or the like, or any combination thereof.

In some embodiments, the input of the time prediction model may include the maintenance work order information and the maintenance person level. The output of the time prediction model may include the maintenance time of the maintenance person under the corresponding maintenance person level.

Please refer to FIG. 2 for details about the maintenance work order information.

In some embodiments, the time prediction model may be obtained by training a plurality of labeled fourth training samples. The fourth training sample of the time prediction model may include sample maintenance work order information and a sample maintenance person level, and the label may be an actual maintenance time of the maintenance person under the corresponding maintenance person level. The process for training the time prediction model is similar to that of the maintenance prediction model, for which reference may be made to the relevant description above.

In some embodiments, the time prediction model may include a feature extraction layer and a time prediction layer.

An input of the feature extraction layer may include the maintenance work order information and the maintenance person level. An output of the feature extraction layer may include a work order feature, and the work order feature may reflect a relevant feature about the maintenance work order information and the maintenance person level.

An input of the time prediction layer may include the work order feature. An output of the time prediction layer may include the input maintenance time of the maintenance person under the corresponding maintenance person level.

In some embodiments, the feature extraction layer and the time prediction layer may be jointly trained.

In some embodiments, a fifth training sample of the joint training includes the sample maintenance work order information and the sample maintenance person level, and the label is the actual maintenance time of the maintenance person under the maintenance person level corresponding to the sample. The joint training of the feature extraction layer and the time prediction layer is similar to the joint training of the audio feature extraction layer and the audio anomaly recognition layer, please refer to the relevant description above.

When the first or second confidence level is not greater than the confidence level threshold, the maintenance work order information and the maintenance person level may be processed to predict the maintenance time through the time prediction model. In this way, the accuracy of the predicted maintenance time may be more accurate, which helps to get a preliminary understanding of the time of maintenance work and facilitates the subsequent allocation of the maintenance person.

When both the first and second confidence levels are greater than the confidence level threshold, the maintenance time of the maintenance person under the corresponding maintenance person level may be determined based on the maintenance person level, the maintenance type, and the maintenance difficulty level, which facilitates a time planning for maintenance works with different difficulty levels, and is helpful for the subsequent allocation of a corresponding maintenance person.

In some embodiments, the man-hour requirement may further include a travel time. A current location of a maintenance person to be allocated and a maintenance location of the maintenance task may be obtained; and a path planning and the travel time of the maintenance person to be allocated may be determined based on the current location and the maintenance location.

The travel time refers to a time required for the maintenance person to arrive at the maintenance location from the current location. The travel time may be determined based on a given map engine, a planned path, a current traffic condition, and means of transportation, etc.

The maintenance person to be allocated refers to a maintenance person available for allocation.

The current location refers to a latitude and longitude where the current maintenance person to be allocated is located. The current location may be obtained by accessing a mobile device of the maintenance person by the smart gas safety management platform.

The maintenance location refers to a location corresponding to the maintenance work order. The maintenance location may be uploaded by the user and included in the maintenance work order information.

The path planning refers to planning a path for the maintenance person to reach the maintenance location from the current location according to a given map and the maintenance location. The path planning may be determined based on the given map engine, the current location, and the maintenance location.

Taking the travel time into the man-hour requirement consideration facilitates a more reasonable allocation of the maintenance person. For example, the maintenance person who is close to the maintenance location may be allocated preferentially.

FIG. 5 is a schematic diagram illustrating an exemplary process for determining a material requirement according to some embodiments of the present disclosure.

In some embodiments, based on the maintenance type 330 and the maintenance difficulty level 350, a standard material requirement 520 for at least one maintenance task may be determined through a standard material library 510. Please refer to FIG. 2 for descriptions of the maintenance type and the maintenance difficulty level.

The standard material library 510 refers to a database storing a standard material and a usage volume of each maintenance condition. For example, the standard material library 510 may store standard materials and usage volumes corresponding to various maintenance types and various maintenance difficulty levels.

In some embodiments, the standard material library 510 may be obtained based on the smart gas data center.

The standard material requirement 520 refers to a standard maintenance material requirement for maintaining a gas device.

In some embodiments, the smart gas safety management platform may determine the standard material requirement 520 for at least one maintenance task through the standard material library 510 based on the maintenance type 330 and the maintenance difficulty level 350.

In some embodiments, a retrieval result 540 may be determined through a historical maintenance database 530 based on the maintenance work order information 310. Please refer to FIG. 2 for details about the maintenance work order information.

The historical maintenance database 530 refers to a database for storing data related to a historical maintenance work order. For example, the historical maintenance database 530 may store an actually used maintenance material, a maintenance person level, etc., corresponding to the historical maintenance work order.

In some embodiments, the historical maintenance database 530 may be obtained based on the smart gas data center.

The retrieval result 540 refers to a result determined by retrieving in the historical maintenance database 530, for example, the retrieval result 540 may be an actually used maintenance material and a maintenance person level of one or more historical maintenance work orders corresponding to the maintenance work order information 310.

In some embodiments, the smart gas safety management platform may determine the retrieval result 540 through the historical maintenance database 530. For example, based on the maintenance work order information 310, a similar historical maintenance work order may be determined by comparison through the historical maintenance database 530, and the actually used maintenance material as well as the maintenance person level may be determined as the retrieval result 540 corresponding to the maintenance work order.

In some embodiments, the material requirement 550 for the at least one maintenance task may be determined based on the retrieval result 540 and the standard material requirement 520. Please refer to FIG. 2 for details on the material requirement. For example, by comparing the actually used maintenance material and the maintenance person level in the retrieval result 540 with the standard material requirement 520, the usage volumes of different materials in the standard material requirement 520 may be adjusted, and the adjusted standard material requirement may be determined as the requirement for the at least one maintenance task.

By using the standard material library 510 and the historical maintenance database 530, the standard material requirement 520 and the retrieval result 540 may be determined, respectively, and by comparing the retrieval result 540 with the standard material requirement 520, the material requirement 550 for the at least one maintenance task can be determined more accurately.

In some embodiments, historical maintenance work order information may be determined based on the maintenance difficulty level; historical similar maintenance work order information may be determined based on the maintenance work order information and the historical maintenance work order information; material usage data may be determined based on the historical similar maintenance work order information, and the material requirement corresponding to the maintenance difficulty level may be determined based on the material usage data and the standard material requirement.

The historical maintenance work order information refers to information related to the historical maintenance work order with the same maintenance difficulty level of the maintenance task corresponding to the maintenance work order information.

In some embodiments, the smart gas safety management platform may determine, based on the maintenance difficulty level, the historical maintenance work orders with the same maintenance difficulty level of the maintenance task corresponding to the maintenance work order information as the plurality of historical maintenance work order information.

The historical similar maintenance work order information refers to information related to the historical maintenance work order similar to the maintenance work order information. In some embodiments, the smart gas safety management platform may determine the plurality of historical similar maintenance work order information based on a preset condition. The preset condition may be that a similarity is greater than a threshold (such as 80%). When the similarity between the historical maintenance work order and the current maintenance work order is greater than 80%, it is determined that the historical maintenance work order is the historical similar maintenance work order.

The material usage data refers to relevant data of the maintenance material used for the maintenance of the gas device.

In some embodiments, the smart gas safety management platform may determine the relevant data of the actually used maintenance material corresponding to the historical similar maintenance work order information as the material usage data.

In some embodiments, the smart gas safety management platform may determine the material requirement corresponding to the maintenance difficulty level through a fusion (such as an averaging, etc.) based on the material usage data and the standard material requirement.

Through the maintenance work order information and the historical maintenance work order information, the historical similar maintenance work order information may be obtained, and the material usage data may be determined, and then using the material usage data and the standard material requirement, the material requirement corresponding to the maintenance difficulty level may be intelligently determined according to the actual usage condition, thereby improving the user experience.

In some embodiments, the material requirement may be determined by performing a weighted summation on the weights of the material usage data and the standard material requirement.

In some embodiments, the weights of the material usage data and the standard material requirement may be determined based on the first confidence level and the second confidence level, and the weight of the standard material requirement is positively correlated with the first confidence level and the second confidence level. For example, the higher the value of the first and/or second confidence level, the greater the weight of the standard material requirement is, and the smaller the weight of the corresponding material usage data is. The corresponding relationship between the weight of the standard material requirement and the values of the first and second confidence levels may be set in advance. Please refer to FIG. 3 for details about the first and second confidence levels.

Determining weights through the first and second confidence levels can make the determined weights more accurate.

In some embodiments, the weight of the material usage data may be determined based on proportions of the plurality of historical similar maintenance work orders in a plurality of feedback clusters and in a plurality of frequency clusters. The greater the proportion of the count of the plurality of historical similar maintenance work orders with a label of good feedback in the feedback clusters is, and the greater the proportion of the count of the plurality of historical similar maintenance work orders with a label of less frequency in the frequency clusters is, the greater the weight of the corresponding material usage data is, and the smaller the weight of the corresponding standard material requirement is. A corresponding relationship between the weight of the material usage data and the above proportions may be set in advance.

The feedback cluster refers to a collection of recorded customer feedback. For example, the plurality of feedback clusters may respectively correspond to labels such as excellent feedback, good feedback, qualified feedback, and poor feedback.

The frequency cluster refers to a collection of maintenance frequencies required to successfully solve the maintenance work order. For example, the plurality of frequency clusters may respectively correspond to labels such as a high frequency, a proper frequency, a qualified frequency, and a low frequency. For example, the maintenance frequency corresponding to the high frequency, the proper frequency, the qualified frequency, and the low frequency may be greater than or equal to 4 frequencies, 3 frequencies, 2 frequencies, and 1 frequency, respectively. The maintenance frequencies corresponding to labels of different frequency clusters may be set according to the actual requirement.

In some embodiments, the plurality of feedback clusters and the plurality of frequency clusters may be obtained based on the smart gas data center. In some embodiments, the plurality of feedback clusters and the plurality of frequency clusters may be determined through a clustering algorithm based on the customer feedback and the maintenance frequencies of the plurality of historical work orders. Please refer to FIG. 6 for details about the above related content.

Determining the weight of the material usage data based on the proportions of the plurality of historical similar maintenance work orders in the plurality of feedback clusters and in the plurality of frequency clusters can make the determined weight of the material usage data more accurate.

FIG. 6 is a flow chart illustrating an exemplary process for determining a work order allocation plan according to some embodiments of the present disclosure. In some embodiments, a process 600 may be executed by the smart gas safety management platform. As shown in FIG. 6, the process 600 includes the following operations.

In 610, obtaining an available allocation time of at least one maintenance person to be allocated. Please refer to FIG. 4 for details about the maintenance person to be allocated.

The available allocation time refers to the time that the maintenance person to be allocated may be available for maintenance. For example, the available allocation time may be determined by subtracting an occupied time from a working time of the maintenance person to be allocated.

In 620, determining, based on the available allocation time and the man-hour requirement, at least one candidate maintenance worker.

The candidate maintenance person refers to a maintenance person to be selected.

In some embodiments, the smart gas safety management platform may determine the at least one candidate maintenance person based on the maintenance person to be allocated with an available allocation time not less than the man-hour requirement.

In some embodiments, the smart gas safety management platform may determine, based on customer feedback and maintenance frequencies of a plurality of historical work orders, a plurality of feedback clusters and a plurality of frequency clusters through a clustering algorithm. The smart gas safety management platform may determine, based on the maintenance work order information, the plurality of feedback clusters and the plurality of frequency clusters, estimated customer feedback and an estimated maintenance frequency of the maintenance work order information through a similarity calculation. The smart gas safety management platform may determine the at least one candidate maintenance person based on the available allocation time, the man-hour requirement, the estimated customer feedback and the estimated maintenance frequency. If the estimated customer feedback is poor and the estimated maintenance frequency is greater than a frequency threshold, the at least one candidate maintenance person is determined through a preset list.

The data corresponding to the plurality of historical work orders includes the plurality of customer feedback and maintenance frequency data. Based on the data of the plurality of historical work orders, each historical work order vector may be constructed, respectively, and then a collection of the historical work order vectors may be obtained.

An element of the historical work order vector may correspond to the historical work order data. The historical work order vector may be determined based on the historical work order data in various ways. In some embodiments, the element of the historical work order vector may correspond to values of the customer feedback and the maintenance frequency of the historical work order data.

In some embodiments, the smart gas safety management platform may obtain the customer feedback and the maintenance frequency corresponding to different historical work orders through the smart gas data center. The customer feedback and the maintenance frequency of the historical work orders may be clustered by the clustering algorithm, and the plurality of feedback clusters and the plurality of frequency clusters may be determined. Different feedback clusters correspond to different feedback labels, and different frequency clusters correspond to different labels for the maintenance frequency required to successfully solve the maintenance work order. Please refer to FIG. 5 for more descriptions of the feedback cluster and the order cluster. The clustering algorithm may include a K-Means clustering or a density-based clustering methods (DBSCAN), etc. The smart gas safety management platform may determine which feedback clusters and frequency clusters different historical work orders belong to through the labels of the customer feedback and the maintenance frequency, the feedback clusters, and the frequency clusters corresponding to the historical work orders.

The estimated customer feedback refers to an estimated customer feedback situation. The estimated maintenance frequency refers to an estimated frequency of the maintenance.

In some embodiments, the maintenance work order information may be represented by a maintenance work order vector.

In some embodiments, the smart gas safety management platform may calculate the similarity between the vector corresponding to the maintenance work order information and the vectors corresponding to the historical work order information corresponding to the centers of the plurality of feedback clusters and the plurality of frequency clusters, respectively. The customer feedback and the maintenance frequency corresponding to the historical work order information with a maximum similarity or with a similarity greater than a similarity threshold may be determined as the estimated customer feedback and the estimated maintenance frequency, respectively. The similarity threshold may be determined according to the actual experience of the user.

In some embodiments, the smart gas safety management platform may determine the at least one candidate maintenance person based on the available allocation time, the estimated customer feedback, and the estimated maintenance frequency. In response to the estimated customer feedback being poor and the estimated maintenance frequency being greater than a frequency threshold (e.g., 3 frequencies), at least one candidate maintenance person may be determined through a preset list.

In some embodiments, the maintenance work order may include a specified work order and a general work order. The specified work order needs to be determined through the preset list. For example, when the maintenance work order is a specified work order, it is necessary to specify a person with a senior maintenance level for maintenance, and the person needs to be determined through a preset list such as a list of person with the senior maintenance level.

The frequency threshold refers to a maximum value of the maintenance frequency. For example, the frequency threshold may be 3 frequencies. The frequency threshold may be manually set in advance. The frequency threshold may further be determined in other ways.

The preset list refers to a preset list of the maintenance person. For example, the preset list may be a list of the maintenance person whose maintenance level is senior. The preset list may be manually set in advance. The preset list may further be determined in other ways.

Determining the at least one candidate maintenance person through the available allocation time, the man-hour requirement, the estimated customer feedback and the estimated maintenance frequency in combination with a previous situation of the user may make the determination of the candidate person more accurate and reasonable.

In 630, determining, based on the material requirement and the at least one candidate maintenance person, a target maintenance person for the at least one maintenance task in the work order allocation plan.

The target maintenance person refers to a maintenance person who finally perform the maintenance tasks.

In some embodiments, different candidate maintenance persons may correspond to different usage volumes of different material requirements. The smart gas safety management platform may determine the corresponding candidate maintenance person with the smallest usage amount of the material requirement as the target maintenance person. Different candidate maintenance persons correspond to the use volumes of different material requirements. According to the historical work order information of the candidate maintenance person, the usage volumes of the material requirements corresponding to the maintenance types and the maintenance difficulty levels of different maintenance tasks may be calculated.

Determining the at least one candidate maintenance person through the available allocation time and the man-hour requirement can make the determination of the candidate maintenance person more reasonable, and determining the target maintenance person for the maintenance task in the work order allocation plan by using the material requirement and combining the candidate maintenance person can make the determination of the target maintenance person more accurate.

In some embodiments, at least one maintenance work order in a preferred plan corresponding to previous i maintenance work orders may be determined as the at least one priority allocation work order. The determining the preferred plan corresponding to the previous i maintenance work orders includes: in response to a man-hour requirement of an i-th maintenance work order being not greater than a preset man-hour, determining the preferred plan corresponding to the previous i maintenance work orders and a planning value of the preferred plan based on a comparison of a first value and a second value. The first value is determined based on a preferred plan that does not include the i-th maintenance work order. The second value is determined based on a value impact of the i-th maintenance work order and a reference plan corresponding to previous i−1 maintenance work orders. A plan man-hour of a reference plan is relevant to the man-hour requirement of the i-th maintenance work order. In response to the man-hour requirement of the i-th maintenance work order being greater than the preset man-hour, the preferred plan corresponding to the previous i maintenance work orders and the planning value of the preferred plan may be determined based on the reference plan corresponding to the previous i−1 maintenance work orders. Please refer to FIG. 5 for details on the maintenance work order.

The previous i maintenance work orders refer to i maintenance work orders before any maintenance work order after the maintenance work orders are arranged in any order. The value of i may be a natural number. The maximum value of i may be the number of the maintenance work orders. i may start taking value from a maximum value q. q is the number of the maintenance work orders.

The work order allocation plan includes the preferred plan. The preferred plan refers to the best plan selected from various feasible work order allocation plans. For example, the preferred plan may be the plan with the greatest sum of values of the maintenance work orders among the work order allocation plans. The work order allocation plan may include which maintenance work orders may be specifically maintained. The value of the maintenance work order may be an improvement of the user experience brought by the maintenance work order.

The preferred plan includes at least one priority allocation work order. The priority allocation work order refers to a work order that is allocated first.

In some embodiments, the smart gas safety management platform may judge whether the man-hour requirement of the i-th maintenance work order is not greater than the preset man-hour.

The preset man-hour refers to the preset man-hour for a work order maintenance. The preset man-hour may be any value less than or equal to the remaining man-hour of the work order maintenance.

In some embodiments, the smart gas safety management platform may determine the preset man-hour based on a preset rule. The preset rule may be a preset rule on how to determine the preset man-hour. For example, the preset rule may be to calculate the remaining man-hour of the work order maintenance as the preset man-hour. Exemplarily, the preset man-hour may be represented by W (W=U−Σwₓ), where U indicates a total available man-hour for the work order maintenance, and Σwₓ indicates a sum of the man-hours of the maintenance work orders selected from the q-th to the (i+1)th maintenance work order.

In some embodiments, it may be judged whether the man-hour requirement of the i-th maintenance work order is not less than the preset man-hour by making a difference. For example, making the difference between the man-hour requirement of the i-th maintenance work order and the preset man-hour, if the difference concluded by man-hour requirement-pre-set man-hour is greater than or equal to 0, the man-hour requirement of the i-th maintenance work order is not less than the preset man-hour; and if the difference is less than 0, the man-hour requirement of the i-th maintenance work order is less than the preset man-hour.

In response to the man-hour requirement of the i-th maintenance work order being not greater than the preset man-hour, the preferred plan corresponding to the previous i maintenance work orders and a planning value of the preferred plan may be determined based on a comparison of a first value and a second value.

The first value refers to a total value of the maintenance work orders in the preferred plan under the premise that the i-th maintenance work order is not included. For example, when the current maintenance work order is the 10th work order, the first value is the value of the preferred plan that does not include the 10th maintenance work order, that is, only the previous 9 maintenance work orders are considered.

In some embodiments, the first value may be determined based on the preferred plan that does not include the i-th repair work order.

In some embodiments, the first value may be represented by formula (1):

f₁=f(i−1,W) (1)

where, f(i−1,W) indicates the value of the preferred plan of the previous i−1 maintenance work orders under the condition of the available man-hour W (at this time, the available man-hour is the same as the preset man-hour).

The smart gas safety management platform may determine the preferred plan of the previous i−1 maintenance work orders without including the i-th maintenance work order, and may calculate the value of the preferred plan as the first value f₁.

The second value refers to a total value of the maintenance work orders in the reference plan of the i-th maintenance work order and the previous i−1 maintenance work orders under the premise that the i-th maintenance work order is included. For example, when the current maintenance work order is the 10th work order, the second value is the total value of the 10th maintenance work order and the maintenance work orders in a reference plan of the previous i−1 maintenance work orders.

In some embodiments, the second value may be determined based on a value impact of the i-th maintenance work order and corresponding to the reference plan of the previous i−1 maintenance work orders. A plan man-hour of the reference plan is relevant to the man-hour requirement of the i-th maintenance work order.

The reference plan refers to a feasible plan from the (i−1)th maintenance work order to the first maintenance work order.

In some embodiments, the smart gas safety management platform may calculate the difference between the preset man-hour and the man-hour requirement of the i-th maintenance work order as the plan man-hour of the reference plan.

In some embodiments, the second value may be represented by formula (2):

f₂=f(i−1,W−wᵢ)+vᵢ (2)

where, f(i−1,W−wᵢ) indicates the maximum value that may be brought by the reference plan of the previous i−1 maintenance work orders under a condition of available man-hour W−wᵢ (at this time, the available man-hour is equal to the preset man-hour minus the man-hour requirement of the i-th maintenance work order), wᵢ indicates the man-hour requirement of the i-th maintenance work order, and vᵢ indicates the value of the i-th maintenance work order.

In some embodiments, the smart gas safety management platform may determine the reference plan of the previous i−1 maintenance work orders under the premise that the i-th maintenance work order is determined, calculate a total value of the maintenance work orders in the reference plan and the i-th maintenance work order, and take the result of the calculation as the second value f₂.

The planning value refers to the total value of the priority allocation work orders selected according to the preferred plan. For example, the planning value may include values including a total revenue brought by all maintenance work orders in the preferred plan, and the improvement of user experience brought by the maintenance work orders, and other values.

In some embodiments, the planning value is related to the material requirement.

In some embodiments, the planning value may be determined based on a material loss. For example, the higher the material loss is, the lower the corresponding planning value may be; the lower the material loss is, the higher the corresponding planning value may be;

Through correlating the planning value with the material requirement, the corresponding planning value may be determined through the material loss, so that the priority allocation work order may be better determined.

In some embodiments, the smart gas safety management platform may compare the first value with the second value, and use the greater value as the planning value. The planning value may be expressed by formula (3):

$$f ( i , W ) = max ( {f}_{1} , {f}_{2} ) = max ( f ( i - 1 , W ) , f ( i - 1 , W - {w}_{i} ) + {v}_{i} ) \qquad ( 3 )$$

where, f(i−1,W) and f(i−1,W−wᵢ) may be determined by performing the determination of the above content after judging the size relationship between the man-hour requirement of the i−1th maintenance work order and the corresponding preset man-hour/available man-hour. For example, when the man-hour requirement of the i−1th maintenance work order is not greater than the corresponding preset man-hours, f(i−1,W)=max(f−2,Wᵢ₋₁), f(i−2,Wᵢ₋₁−wᵢ₋₂)+vᵢ₋₁), where Wₚ₋₁ is the preset man-hour corresponding to the i−1-th maintenance work order, and wᵢ₋₂ is the man-hour requirement of the (i−2)th maintenance work order, is the value of the i-th maintenance work order. Recursion may be performed as above until the planning value f(i,W) is determined. When i is 0, selecting the maintenance work order whose preset working hour or available working hour does not exceed W or W−wᵢ from 0 maintenance work orders indicates that there is no corresponding maintenance work order, and the value at this time is 0. When the preset man-hour W or the available man-hour is 0, selecting the maintenance work order with the preset man-hour or the available man-hour of 0 from the i maintenance work orders indicates that there is no corresponding maintenance work order, and the value at this time is 0.

The smart gas safety management platform may determine the at least one maintenance work order in the preferred plan corresponding to the planning value as the at least one priority allocation work order.

In response to the man-hour requirement of the i-th maintenance work order being greater than the preset man-hour, the preferred plan corresponding to the previous i maintenance work orders and the planning value of the preferred plan may be determined based on the reference plan corresponding to the previous i−1 maintenance work orders.

In some embodiments, the smart gas safety management platform may determine the maximum value corresponding to the previous i−1 maintenance work orders under the condition of available man-hour W (at this time, the available man-hour is equal to the preset man-hour), and take the maximum value f(i−1,W) as the planning value. The maximum value of the previous i−1 maintenance work orders may be determined by performing the above content when i=i−1. For example, the relationship between the i−1th maintenance work order and the corresponding preset man-hour is judged; and when the man-hour requirement of the i−1th maintenance work order is not greater than the corresponding preset man-hour, the planning value may be determined by a recursion on f(i−1,W)=max(f(i−2,W), f(i−2,W−wᵢ₋₁)+vᵢ₋₁) according to the formula (3) and the descriptions thereof.

In some implementations, the plurality of maintenance work orders with the smallest total usage volume of the material requirement in the preferred plan may be allocated first. During the allocation, the maintenance work order with higher maintenance difficulty level may be allocated first, which can avoid the situation that the maintenance person with higher maintenance level is occupied by the maintenance work orders with lower maintenance difficulty level, and no maintenance person may handle the maintenance work orders with higher maintenance difficulty level.

By determining the priority allocation work orders based on the preferred plan, the work order allocation plan can be more in line with a user expectation, and manpower and material resources can be saved at the same time.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure.

What is claimed is:

1. A method for creating a smart gas call center work order, wherein the method is executed by a smart gas safety management platform of an Internet of things (IoT) system for creating a smart gas call center work order, and the method comprises:
obtaining maintenance work order information;
determining, based on the maintenance work order information, a maintenance type and a maintenance difficulty level of at least one maintenance task;
predicting, based on the maintenance type and the maintenance difficulty level, a man-hour requirement and a material requirement for the at least one maintenance task; and
determining, based on the man-hour requirement and the material requirement, a work order allocation plan.

2. The method of claim 1, wherein the IoT system for creating the smart gas call center work order further includes: a smart gas user platform, a smart gas service platform, a smart gas sensor network platform, and a smart gas object platform;
the smart gas service platform is configured to send the work order allocation plan to the smart gas user platform;
the smart gas object platform is configured to obtain an execution progress of the work order allocation plan and transmit the work order allocation plan to the smart gas safety management platform through the smart gas sensor network platform; and
wherein
the smart gas user platform includes a gas user sub-platform and a supervision user sub-platform;
the smart gas service platform includes a smart gas usage service sub-platform and a smart supervision service sub-platform;
the smart gas safety management platform includes a smart gas emergency maintenance management sub-platform and a smart gas data center, wherein the smart gas emergency maintenance management sub-platform includes a device safety monitoring management module, a safety alarm management module, a work order dispatch management module, and a material management module;
the smart gas sensor network platform includes a smart gas device sensor network sub-platform and a smart gas maintenance engineering sensor network sub-platform; and
the smart gas object platform includes a smart gas device object sub-platform and a smart gas maintenance engineering object sub-platform.

3. The method of claim 1, wherein the determining, based on the maintenance work order information, a maintenance type and a maintenance difficulty level of at least one maintenance task includes:
determining the maintenance type, a first confidence level of the maintenance type, the maintenance difficulty level, and a second confidence level of the maintenance difficulty level by processing the maintenance work order information based on a maintenance prediction model, wherein the maintenance prediction model is a machine learning model.

4. The method of claim 3, wherein an input of the maintenance prediction model further includes an audio data feature or an image data feature, the audio data feature is obtained through an audio feature extraction layer of an audio recognition model, the image data feature is obtained through an image feature extraction layer of an image recognition model, the audio recognition model includes the audio feature extraction layer and an audio anormaly recognition layer, the image recognition model includes the image feature extraction layer and an image anormaly recognition layer, the audio anormaly recognition layer is configured to determine whether audio data is abnormal based on the audio data feature, the image anormaly recognition layer is configured to determine whether image data is abnormal based on the image data feature, and the image recognition model and the audio recognition model are machine learning models.

5. The method of claim 3, wherein the man-hour requirement includes a maintenance time, and the predicting, based on the maintenance type and the maintenance difficulty level, a man-hour requirement and a material requirement for the at least one maintenance task includes:
judging whether the first confidence level and the second confidence level are greater than a confidence level threshold; and
in response to the first confidence degree and the second confidence degree being greater than the confidence level threshold, determining, based on a maintenance person level, the maintenance type, and the maintenance difficulty level, a maintenance time of a maintenance person under the maintenance person level.

6. The method of claim 5, further comprising:
in response to the first confidence level or the second confidence level being not greater than the confidence level threshold, predicting the maintenance time of the maintenance person under the maintenance person level by processing the maintenance work order information and the maintenance person level based on a time prediction model, wherein the time prediction model is a machine learning model.

7. The method of claim 5, wherein the man-hour requirement also includes a travel time, and the method further comprises:
obtaining a current location of a maintenance person to be allocated and a maintenance location of the maintenance task; and
determining, based on the current location and the maintenance location, a path planning and the travel time of the maintenance person to be allocated.

8. The method of claim 1, wherein the predicting, based on the maintenance type and the maintenance difficulty level, a man-hour requirement and a material requirement for the at least one maintenance task includes:
determining, based on the maintenance type and the maintenance difficulty level, a standard material requirement for the at least one maintenance task through a standard material library;
determining, based on the maintenance work order information, a retrieval result through a historical maintenance database; and
determining, based on the retrieval result and the standard material requirement, the material requirement for the at least one maintenance task.

9. The method of claim 8, further comprising:
determining, based on the maintenance difficulty level, historical maintenance work order information;
determining, based on the maintenance work order information and the historical maintenance work order information, historical similar maintenance work order information;
determining material usage data based on the historical similar maintenance work order information; and
determining, based on the material usage data and the standard material requirement, the material requirement corresponding to the maintenance difficulty level.

10. The method of claim 1, wherein the determining, based on the man-hour requirement and the material requirement, a work order allocation plan includes:
obtaining an available allocation time of at least one maintenance person to be allocated;
determining, based on the available allocation time and the man-hour requirement, at least one candidate maintenance person; and
determining, based on the material requirement and the at least one candidate maintenance person, a target maintenance person for the at least one maintenance task in the work order allocation plan.

11. The method of claim 10, wherein the determining, based on the available allocation time and the man-hour requirement, at least one candidate maintenance person includes:
determining, based on customer feedback and maintenance frequencies of a plurality of historical work orders, a plurality of feedback clusters and a plurality of frequency clusters through a clustering algorithm;
determining, based on the maintenance work order information, the plurality of feedback clusters, and the plurality of frequency clusters, estimated customer feedback and an estimated maintenance frequency of the maintenance work order information through a similarity calculation; and
determining the at least one candidate maintenance person based on the available allocation time, the man-hour requirement, the estimated customer feedback, and the estimated maintenance frequency, wherein if the estimated customer feedback is poor and the estimated maintenance frequency is greater than a frequency threshold, the at least one candidate maintenance person is determined through a preset list.

12. The method of claim 10, wherein the work order allocation plan includes a preferred plan, the preferred plan includes at least one priority allocation work order, and determining the preferred plan includes:
determining at least one maintenance work order in a preferred plan corresponding to previous i maintenance work orders as the at least one priority allocation work order, wherein determining the preferred plan corresponding to the previous i maintenance work orders includes:
in response to a man-hour requirement of an i-th maintenance work order being not greater than a preset man-hour, determining the preferred plan corresponding to the previous i maintenance work orders and a planning value of the preferred plan based on a comparison of a first value and a second value, wherein the first value is determined based on a preferred plan that does not include the i-th maintenance work order, the second value is determined based on a value impact of the i-th maintenance work order and a reference plan corresponding to previous i−1 maintenance work orders, and a plan man-hour of the reference plan is relevant to the man-hour requirement of the i-th maintenance work order; and
in response to the man-hour requirement of the i-th maintenance work order being greater than the preset man-hour, determining the preferred plan corresponding to the previous i maintenance work orders and the planning value of the preferred plan based on the reference plan corresponding to the previous i−1 maintenance work orders.

13. The method of claim 11, wherein the planning value is related to the material requirement.

14. An IoT (Internet of things) system for creating a smart gas call center work order, wherein a smart gas safety management platform of the IoT system for creating a smart gas call center work order is configured to:
obtain maintenance work order information;
determine, based on the maintenance work order information, a maintenance type and a maintenance difficulty level of at least one maintenance task;
predict, based on the maintenance type and the maintenance difficulty level, a man-hour requirement and a material requirement for the at least one maintenance task; and
determine, based on the man-hour requirement and the material requirement, a work order allocation plan.

15. The IoT system of claim 14, wherein the IoT system further includes: a smart gas user platform, a smart gas service platform, a smart gas sensor network platform and a smart gas object platform;
the smart gas service platform is configured to send the work order allocation plan to the smart gas user platform;
the smart gas object platform is configured to obtain an execution progress of the work order allocation plan, and transmit the work order allocation plan to the smart gas safety management platform through the smart gas sensor network platform; and
wherein
the smart gas user platform includes a gas user sub-platform and a supervision user sub-platform;
the smart gas service platform includes a smart gas usage service sub-platform and a smart supervision service sub-platform;
the smart gas safety management platform includes a smart gas emergency maintenance management sub-platform and a smart gas data center, wherein the smart gas emergency maintenance management sub-platform includes a device safety monitoring management module, a safety alarm management module, a work order dispatch management module and a material management module;
the smart gas sensor network platform includes a smart gas device sensor network sub-platform and a smart gas maintenance engineering sensor network sub-platform; and
the smart gas object platform includes a smart gas device object sub-platform and a smart gas maintenance engineering object sub-platform.

16. The IoT system of claim 14, wherein the smart gas safety management platform is further configured to:
determine the maintenance type, a first confidence level of the maintenance type, the maintenance difficulty level, and a second confidence level of the maintenance difficulty level by processing the maintenance work order information based on a maintenance prediction model, wherein the maintenance prediction model is a machine learning model.

17. The IoT system of claim 16, wherein the man-hour requirement includes a maintenance time, and the smart gas safety management platform is further configured to:
judge whether the first confidence level and the second confidence level are greater than a confidence level threshold; and
in response to the first confidence degree and the second confidence degree being greater than the confidence level threshold, determine, based on a maintenance person level, the maintenance type, and the maintenance difficulty level, a maintenance time of a maintenance person under the maintenance person level.

18. The IoT system of claim 14, wherein the smart gas safety management platform is further configured to:
determine, based on the maintenance type and the maintenance difficulty level, a standard material requirement for the at least one maintenance task through a standard material library;
determine, based on the maintenance work order information, a retrieval result through a historical maintenance database; and
determine, based on the retrieval result and the standard material requirement, the material requirement for the at least one maintenance task.

19. The IoT system of claim 14, wherein the smart gas safety management platform is further configured to:
obtain an available allocation time of at least one maintenance person to be allocated;
determine, based on the available allocation time and the man-hour requirement, at least one candidate maintenance person; and
determine, based on the material requirement and the at least one candidate maintenance person, a target maintenance person for the at least one maintenance task in the work order allocation plan.

20. A non-transitory computer-readable storage medium, wherein the storage medium stores computer instructions, when the computer instructions are executed by a processor, the method of claim 1 is implemented.
